(19) United States
(12) Patent Application Publication
(10) Pub. No.: US 2005/0161318 A1
(43) Pub. Date: Jul. 28, 2005

(54) Method and device at an ozone generator unit

(76) Inventor: Jan Arlemark, Hollviken (SE)

Correspondence Address: Steven S. Payne, Suite 1005, 1101 17th Street N.W., Washington, DC, 20036, US

(21) Appl. No.: 10/956,369

(22) Filed: Oct. 4, 2004

(30) Foreign Application Priority Data
Apr. 5, 2002 (SE) 0201026-2

(51) Int. Cl. B01J 19/08; B01J 19/12

(52) U.S. Cl. 204/176; 422/186.07

(57) ABSTRACT

A method and apparatus for improving the yield of ozone gas in a closed ozone generator unit. In a closed ozone generator unit, oxygen gas is transformed into ozone gas by means of alternating current, the oxygen gas being substantially pressurized before entry into the unit. The unit is exposed to an external pressure substantially equal to or higher than the pressure of the oxygen gas.

### TECHNICAL FIELD

The present invention relates to a method and device for improving the yield of ozone gas in a closed ozone generator unit, where oxygen gas is transformed into ozone gas by means of alternating current and the oxygen gas is substantially pressurized before entry into the ozone generator unit.

### BACKGROUND OF THE INVENTION

Ozone gas is used to an increasing extent in many industrial applications, not the least fresh or waste water treatment, where it can destruct or remove organic material, and in the paper making industry for bleaching purposes.

The demand for ozone is very high and steadily increasing.

Ozone is generated by so called dark or cold electrical discharges (“silent discharge corona”) in oxygen gas or oxygen-enriched gas mixtures.

An ozone generator unit of the kind referred above is shown and described in WO 9701507. The unit basically consists of two ceramic plates and a metal electrode in an enclosed and gas-tight space between the plates. Oxygen gas (O₂) is supplied to this space and is transformed therein to ozone (O₃) by means of alternating current supplied to the electrode.

Another known ozone generator unit is shown in WO 0220398, where the oxygen gas is pressurized before entry into the unit.

Although the yield from these ozone generator units is much higher than the yield from more conventional ozone generator units, improvements in this respect (and others) are always desirable.

The main object of the invention is accordingly to increase the yield of ozone gas from the generator unit but also to prevent bulging or bursting of the generator unit when exposed to the internal pressure.

### THE INVENTION

This is according to the invention accomplished in that the generator unit is exposed to an external pressure substantially equal to or higher than the pressure of the oxygen gas.

The entry pressure of the oxygen gas is up to 20 bar, preferably in the order of 1.5-3 bar.

The generator unit may be submerged in water as cooling liquid and as a second pole, a metal electrode within the unit being a first pole. In this practical design the water has a pressure equal to or higher than the pressure of the oxygen gas.

A closed ozone generator unit may according to previously known technique comprise two ceramic plates forming a closed space containing a metal electrode, supplied with alternating current for transforming supplied oxygen gas into ozone gas. In order to obtain a practically manageable design, both at assembly and service, several such ozone generator units, for example six units, are stacked to an ozone generator assembly. This assembly may be exposed to an external pressure substantially equal to or higher than the pressure of the oxygen gas in each generator unit by being submerged in water as cooling liquid and as a second pole, the electrode within each ozone generator unit being a first pole and the water having said external pressure.

In order to keep the stack of ozone generator units together and to allow distribution of oxygen gas, ozone gas and electricity to and from the separate ozone generator units, the ozone generator assembly may be provided with mounting bars at the connection end of the ozone generator units, said mounting bars being provided with connections for oxygen gas, ozone gas, and electricity, respectively, for further distribution to and from the separate ozone generator units.

A closed container for the ozone generator assembly is preferably used for the pressurized water.

In a practical case four ozone generator assemblies are arranged in the container.

Another presently common technology is to produce ozone in large gas pressure vessels, which implies expensive vessel certification.

With the method and device according to the invention the enclosed gas volume is reduced to less than 5% of the total vessel volume, whereby the vessel can be certified as a pressure water vessel with less stringent safety regulations.

### BRIEF DESCRIPTION OF THE DRAWINGS

The invention will be described in further detail below under reference to the acccompanying drawings, in which

FIG. 1 is a perspective view of an ozone generator assembly according to the invention,

FIG. 2 is a top view to a smaller scale of the ozone generator assembly,

FIG. 3 illustrates the arrangement of four ozone generator assemblies in a common container, and

FIG. 4 illustrates one of these four ozone generator assemblies in the container.

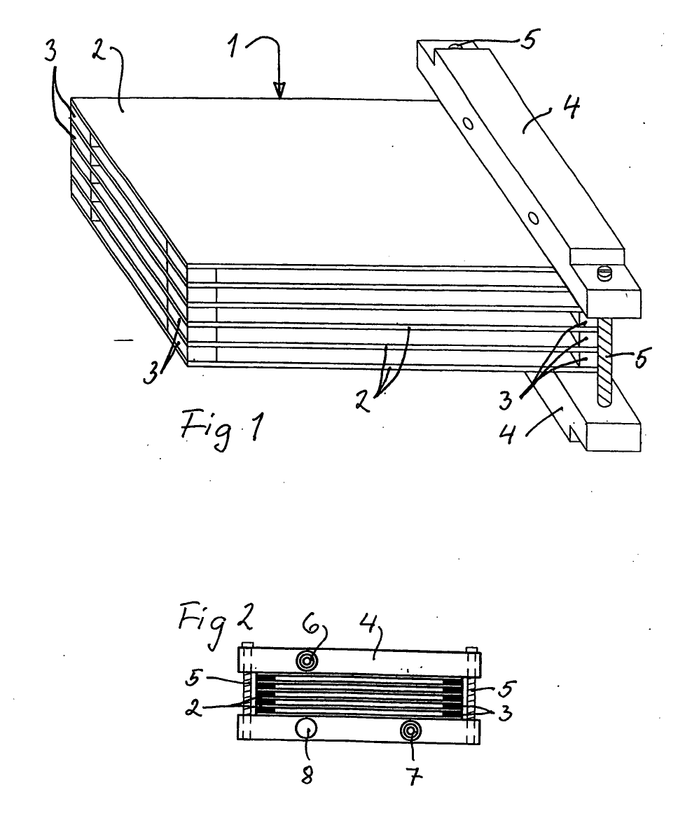

### DETAILED DESCRIPTION OF A PREFERRED EMBODIMENT

An ozone generator assembly 1 as shown in the four figures has as its basic building blocks a number of ozone generator units 2, in the shown example six units. Each of these ozone generator units 2 preferably has the construction as shown in WO 9701507 with two external ceramic plates and a metal electrode, preferably in the form of a net, in an enclosed and gas-tight space between the plates. Means may be provided in said space for accomplishing a winding path for the oxygen gas admitted into the space.

The assembly of for example six units 2 is formed by stacking the units with washers 3, preferably at each corner, so as to provide a distance between two neighboring units. These washers 3 are made of an inert material, for example a ceramic material or glass, and are glued to the ceramic plates of the ozone generator units 2.

Mounting bars 4 may be provided at either side of the stack of units 2 at a connection end thereof and are clamped in position by screws 5 joining the two mounting bars. Alernatively, bonding may be used.

At its top end the mounting bars 4 may be provided with connections 6, 7, 8 for oxygen gas, ozone gas and electricity, respectively, as is illustrated in FIG. 2.

Means (not shown) are provided for distributing in parallel the oxygen gas admitted through the connection 6 (by tubing means not shown) to the different ozone generator units 2 and then for transporting away the ozone gas produced in the units from the connection 7 (by tubing means not shown). Also, means (not shown) are provided for accomplishing internal electrical distribution from the connection 8, to which electricity can be supplied by a cable (not shown), to the electrode in each unit 2.

As is described in more detail in WO 9701507, ozone gas (O₃) is formed from oxygen gas (O₂) in each ozone generator unit 2 when its metal electrode is connected to an alternating current and the outside of each unit is earthed. The voltage may be in the order of 2-6 kV or higher and the frequency 2-100 kHz, preferably 20 kHz. The earthing may preferably be obtained by externally metallizing the generator units 2 and submerging them into a cooling liquid, preferably water.

If each unit 2 has a length in the magnitude of 160 mm and a width in the magnitude of 115 mm, its yield may be in the order of 20 g/h.

It has now been discovered that the yield of the process can be greatly improved by substantially increasing the entry pressure of the oxygen gas supplied to each ozone generator unit 2, for example up to the region of 20 bar but preferably up to 1.5-3 bar. In a practical case the entry pressure was increased to 2.5-3 bar, which resulted in a doubled yield, i e from about 20 g/h to 40 g/h.

An internal pressure increase in each ozone generator unit 2 may lead to an outward bulging of its plates and ultimately bursting of the unit. In order to obviate this drawback it is according to the invention proposed to submerge the ozone generator assemblies 1 in a pressurized cooling medium, such as water, also acting as the second pole or earth for each unit 2, possibly externally metallizied.

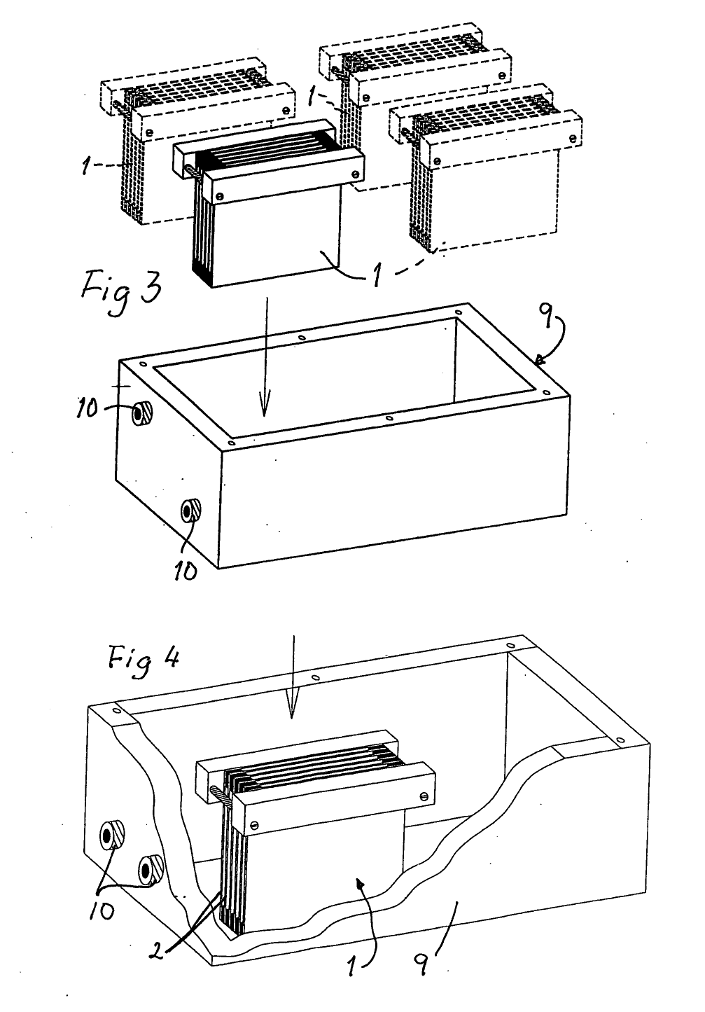

FIGS. 3 and 4 are intended to illustrate that a number of ozone generator assemblies 1 are arranged in a closed container 9, whose lid is not shown. For the electrical connection to each ozone generator assembly 1 a ceramic tube for an electric cable may extend between a mounting bar 4 of the assembly up through the lid (in a sealed manner).

As illustrated in FIG. 3 the number of assemblies 1 in each container 9 may be four, but any other number is possible. The container 9 is provided with connections 10 for supply and removal of cooling liquid, such as water or the like, to the interior of the container 9.

The water pressure (if water is choosen as the cooling liquid) may preferably be equal to or higher than the pressure of the oxygen gas supplied to each ozone generator unit 2.

The systems for administering the gases, the water and the alternating current are not shown or described in detail. However, the pressurized water may emanate from a separate container, where the water is pressurized by means of a pressurized gas over a membrane, or from the ordinary water system, the water pressure being regulated by means of for example a solenoid valve, as is well known in the art.

The heat generated in the water by the process may be extracted in a plate heat exchanger or the like and subsequently utilized.

It may be advantageous to provide the exposed surfaces of the ozone generator units 2 with aluminum foil or a silver layer.

1-10. (canceled)

11. A method for improving the yield of ozone gas in a closed ozone generator unit, wherein oxygen gas in transformed into ozone gas by means of alternating current and the oxygen gas is substantially pressurized before entry into the ozone generator unit, wherein the generator unit is exposed to an external pressure substantially equal to or higher than the pressure of the oxygen gas.

12. A method according to claim 11, wherein the entry pressure of the oxygen gas is up to 20 bar.

13. A method according to claim 12, wherein the entry pressure of the oxygen gas is on the order of 1.5-3 bar.

14. A method according to claim 11, wherein the generator unit is submerged in water as a cooling liquid and as a second pole, a metal electrode within the unit being a first pole, wherein the water has a pressure equal to or higher than the pressure of the oxygen gas.

15. A device for improving the yield of ozone gas in a closed ozone generator unit, which comprises two ceramic plates forming a closed space containing a metal electrode, supplied with alternating current for transforming supplied oxygen gas into ozone gas, wherein the oxygen gas is substantially pressurized before entry into the ozone generator unit, wherein the generator unit is arranged in a container for water with a pressure equal to or higher than the pressure of the oxygen gas, the water acting as a cooling liquid and as a second pole, the electrode within the ozone generator unit being a first pole.

16. A device according to claim 15, wherein the entry pressure of the oxygen gas is up to 20 bar.

17. A device according to claim 16, wherein the entry pressure of the oxygen gas is on the order of 1.5-3 bar.

18. A device according to claim 15, wherein several ozone generator units are stacked to an ozone generator assembly.

19. A device according to claim 18, wherein the ozone generator assembly is provided with mounting bars at the connection end of the ozone generator units and that the mounting bars are provided with connections for oxygen gas, ozone gas, and electricity, respectively, for further distribution to and fro the separate ozone generator units.

20. A device according to claim 18, wherein the ozone generator assembly is arranged in a closed container for water under pressure.

21. A device according to claim 20, wherein a plurality ozone generator assemblies are arranged in the container.

22. A device according to claim 18, further comprising a control system for keeping the water pressure in the container constant.

23. The device according to claim 18, wherein six ozone generator units are stacked.

24. The device according to claim 21, wherein four ozone generator assemblies are arranged in the container.
